(19) United States
(12) Patent Application Publication
(10) Pub. No.: US 2009/0244699 A1
(43) Pub. Date: Oct. 1, 2009

(54) REMOTE CONTROLLED TELESCOPE LENS COVER FOR SMALL TELESCOPES

(76) Inventor: Robert S. Capon, Charlottesville, VA (US)

Correspondence Address: VANCE INTELLECTUAL PROPERTY, PC, 5467 HILL TOP STREET, CROZET, VA, 22932-3167, US

(21) Appl. No.: 12/057,324

(22) Filed: Mar. 27, 2008

(51) Int. Cl. G02B 23/00; G02B 23/16

(52) U.S. Cl. 359/399; 359/511

(57) ABSTRACT

The present invention relates to a remote-controlled telescope lens cover and a telescope fitted with the same.

### FIELD OF THE INVENTION

The present invention relates to a remote-controlled telescope lens cover and a telescope fitted with the same.

### BACKGROUND OF THE INVENTION

A lens cover is a device to protect the optics of a telescope when the instrument is not in use. Lens covers are essential for protecting the telescope from accidental damage, and from keeping out dirt and dust when the telescope is not in use. As an indicator of the indispensable nature of lens covers, virtually every telescope has one.

A Remotely Controlled Observatory (“RCO”) is an astronomical observatory that can be controlled by a person using a remote computer using a network connection to control an observatory computer, which in turn controls the electronic and electromechanical devices in the observatory.

Remotely controlled amateur observatories are becoming increasingly popular because of a number of inexpensive technologies that have become available. These technologies include personal computers, local area networks, wide area networks including the Internet, computer-controlled telescope mounts, computer-controlled focusing devices, sensitive computer-controlled CCD cameras, computer-controlled observatory domes and shutters, cloud and rain sensors, and sophisticated software tools for controlling each of these devices. These RCO's vary widely in sophistication, from modest backyard observatories that can be controlled from inside of a house, to sophisticated observatories that can be controlled over the Internet by an astronomer thousands of miles away.

While all of these functions exist today, at present there are no remotely-controlled lens covers available for amateur RCO's. The current state of the art for RCO's is to leave the lens cover off, and to place the telescope tube in the horizontal position so that the optical surfaces are vertical in order to mitigate the collection of dirt and dust on the optics while the telescope is not in use. Unfortunately, these telescopes are quickly covered by dust, dirt, pollen, insects, and other debris, and the optics need to be cleaned frequently. Because of the remote nature of the RCO's, accessing and cleaning the telescopes is often very difficult or impractical.

Thus, there is a need for a remotely-controlled lens cover for telescopes in RCO's.

### SUMMARY OF THE INVENTION

The present invention provides a novel remotely controlled lens cover for small telescopes, which is useful for Remotely Controlled Observatories (RCO's).

The present invention also provides a novel small telescope fitted with a remotely controlled lens cover.

These and other aspects of the present invention have been accomplished in view of the discovery of a remotely controlled lens cover as described herein.

### DETAILED DESCRIPTION OF THE INVENTION

A small telescope is a telescope with an objective with a diameter of twenty-four inches or less.

In an embodiment, the present invention provides a novel remotely controlled lens cover system, comprising:
a. an electro-mechanically controllable lens cover capable of covering the optics of a small telescope;
b. an observatory computer operably connected to the lens cover;
c. software residing on the observatory computer capable of operating the lens cover; and,
d. a remotely-located computer electronically connected to the observatory computer and capable of controlling the observatory computer.

An electro-mechanically controlled lens cover is a lens cover that is mechanically operated to cover and expose the optics of a small telescope. The mechanism that operates the lens cover is driven electronically, thereby allowing for remote operation.

The lens cover of the present invention can be embodied in a number of mechanical forms, depending on the desires of the operator. Examples of lens covers include (a) a lens cover that opens and closes like an iris; (b) a lens cover that opens and closes with a hinged cover that swings over the telescope optics; (c) a lens cover that opens and closes with multiple hinged covers that open and close like the petals of a flower over the telescope optics; and, (d) a lens cover that is a flexible cloth that rolls across the lens cover like a window-shade.

In another embodiment, software resides on both the remotely located computer and observatory computer so that the remotely located computer is capable of controlling the observatory computer. The controlling of the observatory computer can be achieved by the software on both computers in a number of ways including mirroring the desktop of the observatory computer onto the remotely located computer.

In another embodiment, the remotely located computer is connected to the observatory computer via a network. Examples of networks include the Internet, a wireless Ethernet network, and a wired Ethernet network.

In another embodiment, the observatory computer is connected to the lens cover via an electronic cable.

In another embodiment, the observatory computer is connected to the lens cover via a wireless connection.

In another embodiment, the present invention provides a novel small telescope with a remotely controlled lens cover system, comprising:
a. a telescope with an objective with a diameter of twenty four inches or less;
b. an electro-mechanically controllable lens cover capable of covering the optics of the small telescope;
c. an observatory computer operably connected to the lens cover;
d. software residing on the observatory computer capable of operating the lens cover; and,
e. a remotely-located computer electronically connected to the observatory computer and capable of controlling the observatory computer.

In another embodiment, the present invention provides a remotely controlled observatory, comprising:
a. an observatory housing, comprising: an operationally retractable opening to the sky;
b. a telescope located within the housing and having an objective with a diameter of twenty four inches or less;
c. an electro-mechanically controllable lens cover capable of covering the optics of the small telescope;
d. an observatory computer located within the housing and operably connected to the lens cover;
e. software residing on the observatory computer capable of operating the lens cover; and,
f. a remotely-located computer located outside of the housing and electronically connected to the observatory computer and capable of controlling the observatory computer.

The examples provided in this application are non-inclusive unless otherwise stated. They include but are not limited to the recited examples.

Numerous modifications and variations of the present invention are possible in light of the above teachings. It is therefore to be understood that within the scope of the appended claims, the invention may be practiced other than as specifically described herein.

What is claimed:

1. A remotely controlled lens cover system, comprising:
a. an electro-mechanically controllable lens cover capable of covering the optics of a small telescope;
b. an observatory computer operably connected to the lens cover,
c. software residing on the observatory computer capable of operating the lens cover,
d. a remotely-located computer electronically connected to the observatory computer and capable of controlling the observatory computer.

2. The system of claim 1, wherein the lens cover opens and closes like an iris.

3. The system of claim 1, wherein the lens cover opens and closes with a hinged cover that swings over the telescope optics.

4. The system of claim 1, wherein the lens cover opens and closes with multiple hinged covers that open and close like the petals of a flower over the telescope optics.

5. The system of claim 1, wherein the lens cover is a flexible cloth that rolls across the lens cover like a window-shade.

6. The system of claim 1, wherein the remotely located computer is connected to the observatory computer via a network.

7. The system of claim 6 where the network is the Internet.

8. The system of claim 6 where the network is a wireless Ethernet network.

9. The system of claim 6 where the network is a wired Ethernet network.

10. The system of claim 1, wherein the observatory computer is connected to the lens cover via an electronic cable.

11. The system of claim 1, wherein the observatory computer is connected to the lens cover via a wireless connection.

12. The system of claim 1, wherein software resides on the remotely located computer and the observatory computer, which is capable of allowing the remotely located computer to control the observatory computer.

13. A small telescope with a remotely controlled lens cover system, comprising:
a. a telescope with an objective with a diameter of twenty four inches or less;
b. an electro-mechanically controllable lens cover capable of covering the optics of the telescope;
c. an observatory computer operably connected to the lens cover;
d. software residing on the observatory computer capable of operating the lens cover; and,
e. a remotely-located computer electronically connected to the observatory computer and capable of controlling the observatory computer.

14. A remotely controlled observatory, comprising:
a. an observatory housing, comprising: an operationally retractable opening to the sky;
b. a telescope located within the housing and having an objective with a diameter of twenty four inches or less;
c. an electro-mechanically controllable lens cover capable of covering the optics of the small telescope;
d. an observatory computer located within the housing and operably connected to the lens cover;
e. software residing on the observatory computer capable of operating the lens cover; and,
f. a remotely-located computer located outside of the housing and electronically connected to the observatory computer and capable of controlling the observatory computer.
